(19) United States
(12) Patent Application Publication
(10) Pub. No.: US 2010/0291427 A1
(43) Pub. Date: Nov. 18, 2010

(54) MODULAR POWERTRAIN, SYSTEMS, AND METHODS

(75) Inventor: Peng Zhou, El Cerrito, CA (US)

Correspondence Address: HAVERSTOCK & OWENS LLP, 162 N WOLFE ROAD, SUNNYVALE, CA, 94086, US

(73) Assignee: SINOELECTRIC POWERTRAIN CORPORATION, Sunnyvale, CA (US)

(21) Appl. No.: 12/779,877

(22) Filed: May 13, 2010

Related U.S. Application Data
(60) Provisional application No. 61/178,645, filed on May 15, 2009.

(51) Int. Cl. B60R 16/04; H01M 2/10; B60S 5/06; B23P 6/00

(52) U.S. Cl. 429/100; 29/428; 29/402.08

(57) ABSTRACT

A power delivery system in an electric vehicle comprises a connection backplane configured to receive a plurality of modular batteries. The connection backplane operates to route power, status and control signals between a modular battery back, a controller, and a powertrain. A method of operating an EV comprises determining a route for an EV and an amount of energy required to complete the route. The method further comprises coupling an appropriate number of batteries to a connection backplane, wherein the batteries have sufficient energy to power the EV for the duration of the route.

### REFERENCE TO RELATED APPLICATIONS

The present application claims priority of U.S. Provisional Pat. App. No. 61/178,645, filed May 15, 2009, which is incorporated herein by reference.

### FIELD OF THE INVENTION

The present invention relates to electrical power systems in electric vehicles. More specifically, the present invention relates to apparatus for and methods of electric coupling of a plurality of batteries to the electronics in an electric motor vehicle.

### BACKGROUND OF THE INVENTION

For a multitude of reasons, it is advantageous to use electric vehicles having rechargeable batteries rather than vehicles using internal combustion engines. Electric vehicles (EVs) are inherently more efficient, meaning more energy is used in locomotion than lost to heat than in conventional engines. Also, EVs do not exhaust any byproducts. However, the use of electric vehicles presents technical challenges. For example, the batteries in an electric vehicle must be recharged. Some electric vehicles are commercially targeted toward daily, low mileage use. Such vehicles are ideal for urban commuters. The batteries are chosen to provide a charge for approximately 50 miles before recharging is required. In some applications, electric vehicles drive well predetermined routes. Vehicles such as buses, delivery trucks, mail trucks, garbage trucks and the like travel predetermined, well known routes. However, most of these vehicles have one large battery. In the example of a municipal bus, the battery can be as large as 4 cubic meters and weigh two tons, and is extremely costly. Also, because such a large battery takes several hours to recharge, the batteries are recharged for use for an entire day. Batteries for other large EVs, such as garbage trucks, are of a similar size, weight and cost. Furthermore, it is well known that batteries may emit heat while charging and discharging. In such large batteries, it comes extremely difficult to maintain temperature uniformity throughout the volume of the battery. The heat also cannot be vented or otherwise managed since the battery is a large, closed device. As a result, the lifetime of the battery is greatly reduced due to temperature non-uniformity. Furthermore, battery management units on board buses, garbage trucks, and the like, are generally programmed to be biased for operation of the EV over maintenance of the battery. Especially in the case of buses, because they carry passengers, the battery management system will prefer to keep the bus operating even in the event of some stress condition on the battery, such as overvoltage, undervoltage, over heating, or the like. Such systems cause greater damage to the battery and further decrease overall operational life.

### SUMMARY OF THE INVENTION

Modular battery systems and methods of their use are provided herein. Multiple batteries are able to be coupled to a connection backplane. The batteries are modular, meaning in the broadest sense that they are able to be mechanically and electrically coupled or de-coupled from an EV without disturbing the operation of the EV. The batteries are optimally sized for greatest energy capacity versus size and weight, on the order of 20 kg. Advantageously, an optimum number of batteries is able to be used rather than one large battery that is probably larger, heavier, and costlier than is required for daily commuting or travel along a predetermined route, such as a bus route or a delivery route. An on board controller is able to determine if any of the modular batteries are failing for reasons such as overcurrent or undercurrent, temperature, stress, or any other reason. Therefore, a single malfunctioning battery is able to be at least electrically de-coupled from a power delivery system. The malfunctioning battery is not subjected to further stress for the sake of keeping the EV running, as was a shortcoming in the prior art. The EV is able to remain operational because the battery system is modular, and other batteries are able to power the EV while the malfunctioning battery is replaced. Also, only one 20 kg battery need be replaced, rather than the large, non modular two ton battery described above. As a result, a new modular battery is able to be brought to an EV bus along a route, for example. A malfunctioning battery is easily removed by a serviceperson and a new modular battery is inserted, generally within the time a bus would stop to pick up or let off passengers. Such an operation is not feasible in the prior art. Methods and apparatus to realize these benefits are summarized below.

In one aspect of the invention, a connection backplane in a power delivery system of an EV comprises a plurality of mounting positions, each configured to receive a battery, wherein each mounting position has several coupling means. The several coupling means serve to route power, both high voltage (on the order to power an electric motor) and low voltage (for powering electronics), and communication signals between the battery and the powertrain controller. Preferably, the connection backplane is operable to remove or add a battery during operation of the electric vehicle without impeding the operation. In some embodiments, the mounting positions each comprise a latching mechanism for securing the plurality of batteries to the connection backplane. In some embodiments, the backplane comprises a system ground, which is able to be electrically coupled to the chassis of the EV. In one example, for simplicity of wiring and implementation, the coupling means for routing power in each mounting position is linked to a power bus. Similarly, coupling means for routing communication signals can be linked to a communication bus. In some embodiments, the communications signal comprises a battery status signal, capable of indicating the remaining energy within a battery, or warn of a fault condition such as an overcurrent, undervoltage, or temperature fault. In some embodiments, the battery status signal comprises an indication of the conductivity between a battery and the backplane. Furthermore, the communications signal preferably comprises a battery control signal. For example, the battery control signal comprises a shutdown instruction, which causes a malfunctioning battery to de-couple from the overall power delivery system.

In another aspect of the invention, a method of operating an electric vehicle takes advantage of the backplane described above. The method of operating an electric vehicle comprises determining an amount of energy required to power the electric vehicle for a predetermined route and coupling a appropriate number of batteries to the electric vehicle according to the determined amount of energy. As a result, an EV must only carry enough batteries for a certain trip, optimizing the weight of the EV. Preferably, the method further comprises automatically determining if a battery becomes non functional or sub-optimally functional, for reasons listed above. If so, the battery is de-coupled. In some embodiments, the method also comprises recharging the batteries at the end of the predetermined route. Alternatively, the method calls for recharging the batteries at a charging point along the predetermined route. Still alternatively, malfunctioning or discharged batteries are swapped out at the end of the predetermined route, or along a predetermined route.

### BRIEF DESCRIPTION OF THE DRAWINGS

FIG. 1A shows an EV having a modular battery pack in accordance with an embodiment of the present invention.

FIG. 1B shows a modular battery for the EV of FIG. 1A in accordance with an embodiment of the present invention.

FIG. 2A shows an EV having a connection backplane for receiving modular batteries in accordance with an embodiment of the present invention.

FIG. 2B shows an exemplary embodiment of the connection backplane of FIG. 2A in accordance with an embodiment of the present invention.

FIG. 3 shows the advantages of the modular battery system in operation in accordance with an embodiment of the present invention.

FIG. 4 shows a flowchart of a method of operating an EV in accordance with an embodiment of the present invention.

### DETAILED DESCRIPTION OF THE INVENTION

In the following description, numerous details are set forth for purposes of explanation. However, one of ordinary skill in the art will realize that the invention can be practiced without the use of these specific details. Thus, the present invention is not intended to be limited to the embodiments shown but is to be accorded the widest scope consistent with the principles and features described herein or with equivalent alternatives. Reference will now be made in detail to implementations of the present invention as illustrated in the accompanying drawings. The same reference indicators will be used throughout the drawings and the following detailed description to refer to the same or like parts.

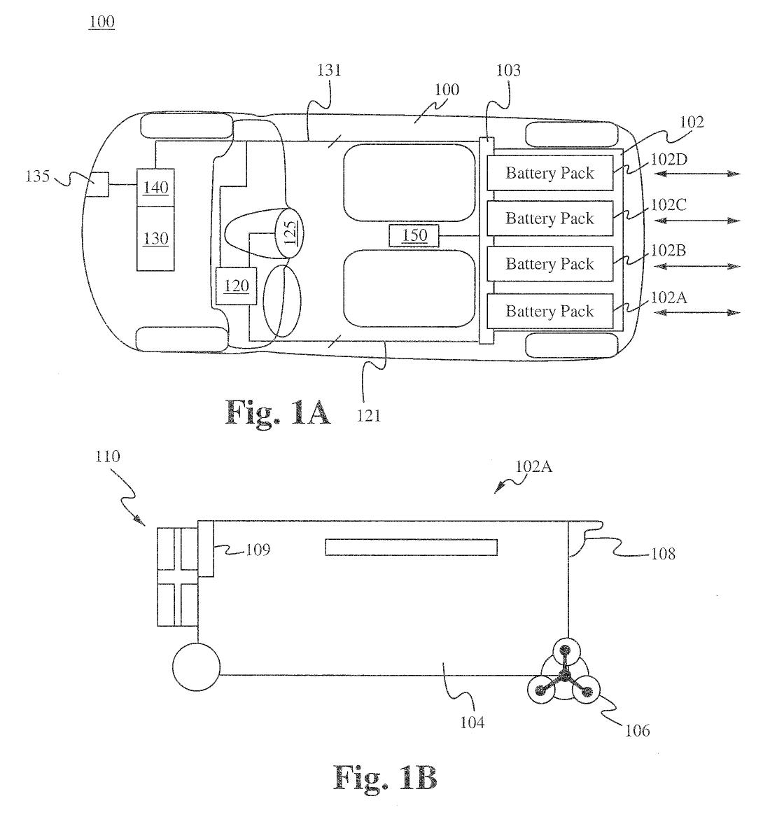

FIG. 1A is a depiction of a generic EV 100. In this depiction, the EV 100 is a small commuter automobile. However, the EV 100 can be any vehicle, such as a bus, garbage truck, etc. The EV 100 has a battery compartment 102. Housed within the battery compartment 102 are several modular batteries 102A-102D. In this example, there are four modular batteries 102A-102D. The batteries 102A-102D are mechanically and electrically coupled to a connection backplane 103. The backplane 103 serves not only as a mechanical and electrical coupling point but also as a support for the batteries 102A-102D. For convenience, the backplane 103 should be mounted in the EV 100 such that it easily accessible by opening a hatch on the EV 100, such as a trunk lid or hatchback door. An operator, such as a driver, is easily able to remove or add one or more of the batteries 102A-102D. In the example of an EV bus, a repair truck can bring spare batteries, or spare batteries may be found in kiosks along the route. The driver can swap out a bad battery for a good one in the time the bus is stopped for passengers embarking and disembarking. The backplane 103 is in electrical communication with an inverter 140 via a power bus 121. The power bus 121 serves to route current from the batteries 102A-102D to the inverter 140. The power bus 121 is both able to route high current for running the motor 130 and low current/low voltage for powering various electronics, such as a controller 120, display 125, and control electronics within the batteries 102A-102D. The high current/high voltage power is applied to the inverter 140, which serves to convert DC power into AC power. Since most EVs use AC motors, the DC current provided by the batteries 102A-102D must be modulated into AC. The AC power is then routed to the motor 130 which drives a transaxle.

The backplane 103 is also in electrical communication with a powertrain controller 120 via a communication bus 131. In some embodiments, the controller 120 is a microprocessor, micro controller, or the like that has been programmed to run the power delivery system of the EV 100. The communication bus 131 delivers a status signal for each of the batteries 102A-102D. In some embodiments, the batteries 102A-102D spontaneously emit status signals indicating either that they are functioning properly or that they are in a fault condition of some sort, such as overcurrent, overvoltage, undervoltage, or overheating. Alternatively, the controller 120 sends a query to each of the batteries 102A-102D to request a status signal or status update. The controller 120 is able to then determine an action with regard to the battery. If the battery is properly functioning, the controller 120 will instruct to battery to continue operating normally, i.e., discharge current or receive a charge. However, if a battery is exhibiting or indicating a fault condition, the controller 120 is able to electrically de-couple the malfunctioning battery. Similarly, if any of the batteries 102A-102D either do not signal at all or do not respond to a query for status, the controller 120 de-couples such batteries. Advantageously, there are other batteries remaining to deliver power to the inverter 140 and thus to the engine 130. When the malfunctioning battery is de-coupled electrically. As a result, the stressor, such as non uniform heat, that was stressing the battery will cease. Therefore, the malfunctioning battery will suffer no further damage. As a result, what is achieved is a longer service life for the batteries 102A-102D. In some embodiments, the controller 120 indicates the condition or status of the batteries 102A-102D on a display screen 125. The display screen 125 displays the remaining charge of the batteries, their temperatures, and any fault conditions that may exist. In some embodiments, the display screen 125 is integrated with other indicators, such as a speedometer. In some embodiments, the controller 120 has more control over the batteries 102A-102D. For example, the controller 120 routs commands via the communication bus 121 and the backplane 103 signaling which of the batteries 102A-102D provide how much power. If one battery 102B is more discharged than another 102C, the controller 120 signals for more power to be drawn from battery 102C than from another battery 102B at a ratio appropriate to their respective levels of charge. Alternatively, the controller 120 queries the driver of the EV 100 through the display 125 how many more kilometers the driver intends to go. The controller 120 then adjusts power output of each of the batteries 102A-102D based on their respective charge, and the optimum rate of discharge for each battery with respect to the remaining travel distance. In some embodiments, the EV 100 comprises an Electric Vehicle Service Equipment (EVSE) 135. EVSEs are standard electrical charging sockets that users of EV are familiar with. Generally, in geographic areas where most EV drivers have a place to park and charge their EV, it may be advantageous to do so.

The backplane 103 is also able to mechanically and electrically couple a thermal management system 150 to the batteries 102A-102D. The thermal management system 150 is able to receive a temperature reading from a temperature sensor 109 (FIG. 1B) on board each of the batteries 102A-102D. The thermal management system 150 monitors the temperature reading for each battery 102A-102D and circulates a cooling liquid or vents air in the battery compartment 102 in order to regulate the temperature of the batteries. Advantageously, because the batteries 102A-102D are modular, there is some space between them where ducts are routed to run cooling fluid or allow air to flow through. FIG. 1B shows an exemplary battery 102A. This disclosure does not restrict the size or form factor of the battery 102A, but it should be of a size and form factor that is easily removable from the battery compartment 102 and movable by a person. To that end, wheels 106 are provided. In this example, the wheels 106 comprise a rotating spindle having three wheels thereon. The wheels 106 effectuate easy sliding motion of the batteries 102A-102D in and out of the battery compartment 102. To further effectuate ease of sliding, a handle 108 is provided. The battery 102A also comprises a temperature sensor 109. The temperature sensor 109 is operable to send temperature information about the battery 102A to the controller 120 along the communication bus 121. The battery 102A further comprises a coupling member 204. The coupling member 204 configured to be received by a corresponding mounting position 103A within the connection backplane 103.

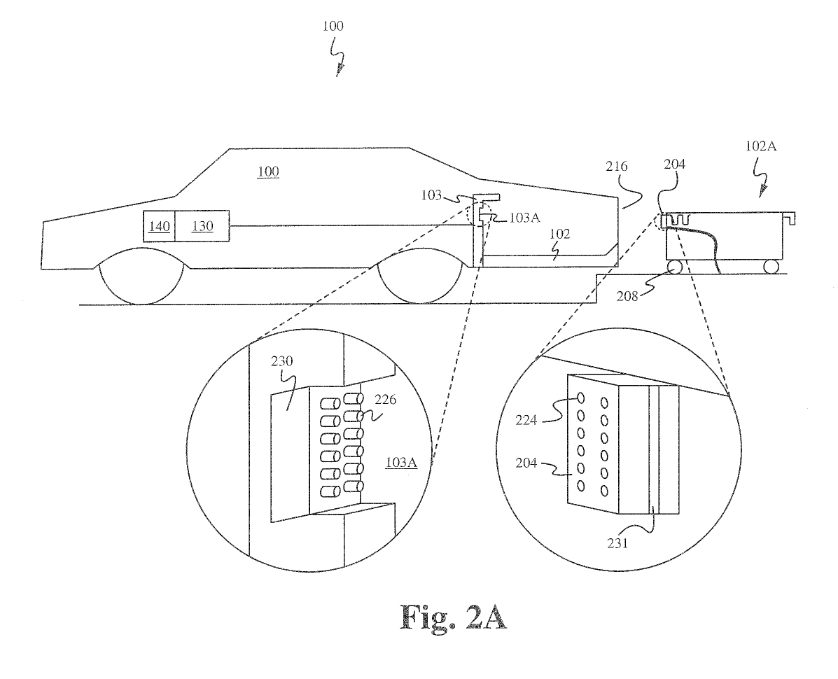

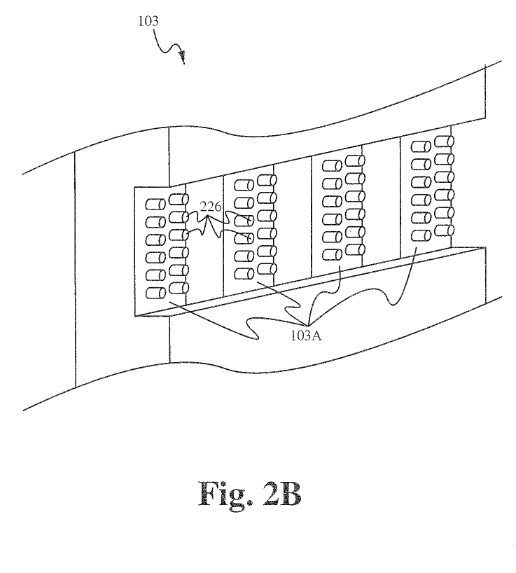

FIG. 2A shows a side view of the EV 100 and details of the connection backplane 103. The backplane 103 comprises several mounting positions 103A. Each mounting position 103A is operable to receive one modular battery 102A and serves as a receptacle, or socket for the coupling member 204. The coupling member 204 and mounting position 103A have corresponding contacts. In this exemplary embodiment, the mounting position 103A has a first set of contacts 226 and the coupling member coupling member 204 has a second set of contacts 224. Upon mating of the coupling member 204 and the mounting position 103A, the several contacts are mechanically coupled, and the several contact points formed by the mechanical coupling of the first set 226 and second set 224 of contacts operate to effectuate the transmission of power to the inverter 140 and motor 130, and communication and status signals between the batteries 102A-102D and the controller 120. To that end, some contacts 226 are electrically coupled to the power bus 131, and some are coupled to the communication bus 121. Still other contacts 226 are coupled to a system ground, such as the chassis of the EV.

The form factors of the coupling member 204, the mounting position 103A, and the sets of contacts 226 and 224 are exemplary and not intended to be limiting. In some embodiments, the form factors are industry standard plug- and receptacle. Alternatively, application specific form factors are designed to suit particular needs. Regardless of the form factor, it is advantageous to secure the battery 102A in place once a successful electrical coupling has occurred. To that end, a latch 230 is provided on the mounting position 103A. The coupling member 204 has a corresponding slit 231 to receive the locking edge of the latch 230. Other alternative latching schemes will be readily apparent to those of ordinary skill having the benefit of this disclosure.

FIG. 2B shows an exemplary embodiment of the connection backplane 103 having four mounting positions 103A. Each mounting position 103A receives a modular battery 102A-102D. A larger EV, or an EV that tows a heavy weight, such as a bus or a garbage truck, will have a connection backplane 103 having more mounting positions 103A since ostensibly such an EV will require considerably more energy to operate. In the example of FIG. 2A, the battery compartment 102 is in the trunk of a sedan-style EV 100. Advantageously, a driver has easy access to the batteries 102A-102D by opening the trunk 216 of the EV 100. As mentioned above, although most EVs have an EVSE 135, it is not convenient to charge an EV 100 in a high density urban setting. To that end, the batteries 102A-102D are easily removed and brought to a dwelling or office for charging.

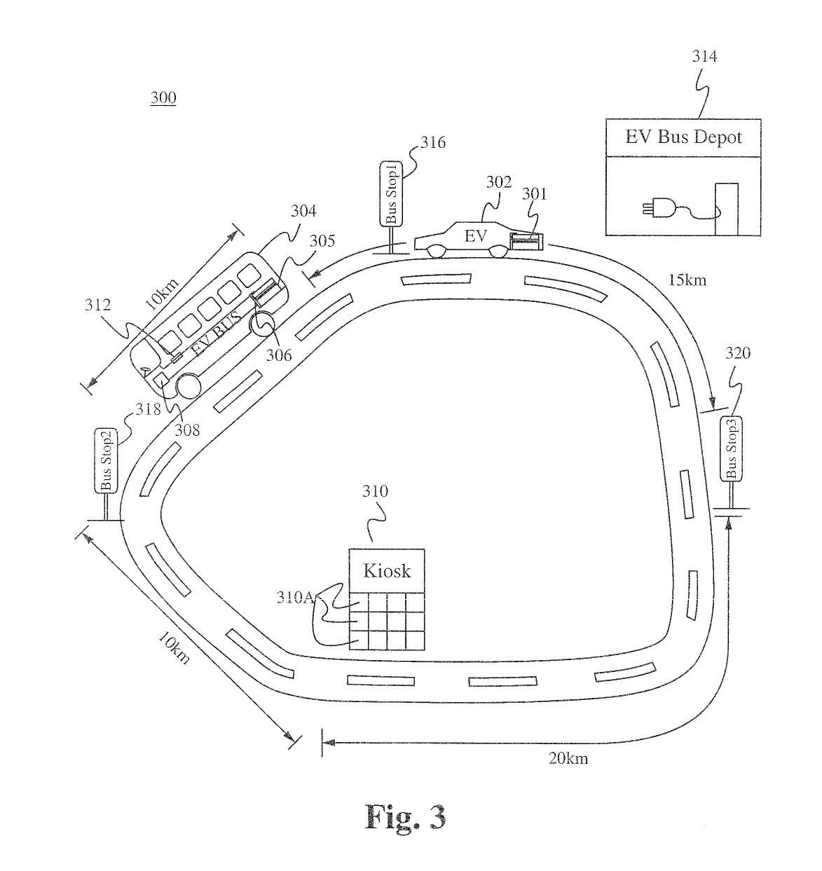

FIG. 3 illustrates the advantages of embodiments of the instant invention in application. An EV bus 304 runs a predetermined route on a daily basis that has a fixed one way trip of 55 km. As discussed above, prior art solutions for EV buses involve one extremely large and unwieldy battery that cannot be removed, especially in the middle of a route. As provided by the current invention, the EV bus 304 comprises a modular battery pack 305. In this example, a first leg of a bus route between Stop 1 316 and stop 2 318 is 10 km. A next leg between stop 2 318 and stop 3 320 is 30 km. The next leg between stop 3 320 and stop 1 316 is 15 km. The total travel distance for this bus route is 55 km. Advantageously, the modular battery pack 305 carries a minimum number of batteries that are necessary to complete the 55 km route. In some embodiments, the EV bus 304 carries additional modular batteries to allow for energy capacity headroom. The batteries in the modular battery pack 305 are electrically coupled to an inverter and a motor 308 via a power bus 306A. The inverter converts DC power from the modular battery pack 305 into AC power to run the motor. The modular battery pack 305 is also electrically coupled to controller 312. The controller 312 monitors the modular battery pack 305 and reports the status of the batteries to a bus operator via a display (not shown). The operator can make informed decisions regarding the remainder of the route. For example, if one battery exhibits an overheating fault condition, the operator is able to de-couple the overheating battery either physically by stopping the bus and manually detaching the battery from the connection backplane 305. Alternatively, the controller 312 automatically electrically decouples the malfunctioning battery. The malfunctioning battery no longer supplies current, and the fault condition is terminated. As discussed above, no prior art solution allows for a battery to be decoupled during operation of the bus. Any controller or operator must prioritize passenger safety and uninterrupted operation of the bus on its route over the long term fitness of the malfunctioning battery. As a result, in prior art systems, a malfunctioning battery is stressed further and potentially damaged beyond repair.

Still referring to FIG. 3, several options are presented to a bus operator of the EV bus 304 when faced with a malfunctioning battery. One exemplary solution is the placement of kiosks 310 along the bus route at appropriate intervals. An appropriate interval is determined by the overall length of the route, the average passenger load of the bus, average traffic along the route, and any other useful parameter. The kiosk 310 holds fresh, fully charged batteries 310A. The operator of the EV bus 304 quickly swaps out a fresh battery 310A from the kiosk 310 and leaves the malfunctioning battery behind in the kiosk 310. A maintenance worker later retrieves malfunctioning batteries and takes them away for repair, or if they are beyond repair for recycling. Because the modular batteries discussed herein are much smaller with respect to batteries in current EV buses or even personal commuter EVs, repair and end of life recycling are much more efficient and cost effective. In some embodiments, the kiosks 310 are operated and managed by a municipal transit agency that runs the EV buses 304. Because of the modular nature and their relatively small form factor, any interruption to service or inconvenience to the passengers due to malfunctioning batteries is minimal. Alternatively, private motorists that own EV autos 302 having the modular battery system 301 are able to take advantage of the kiosks 305, for example by joining a membership that allows them access to the kiosks 310. Alternatively, the kiosks 310 have payment accepting means, such as a credit car reader, cash collector, or an operator that allows for single transactions of swapping a malfunctioning or discharged battery. Should the batteries of an EV bus 304 or an EV 302 discharge entirely and not near a kiosk 310, a serviceperson can bring a spare battery to swap. Still referring to FIG. 3, at the end of a route, the modular batteries of the modular battery pack 305 on the EV bus 304 are all removed for charging at an EV bus depot 314, and new modular batteries are placed into the modular battery pack 305. Again, this operation is able to be done quickly and with minimal interruption to service, if any.

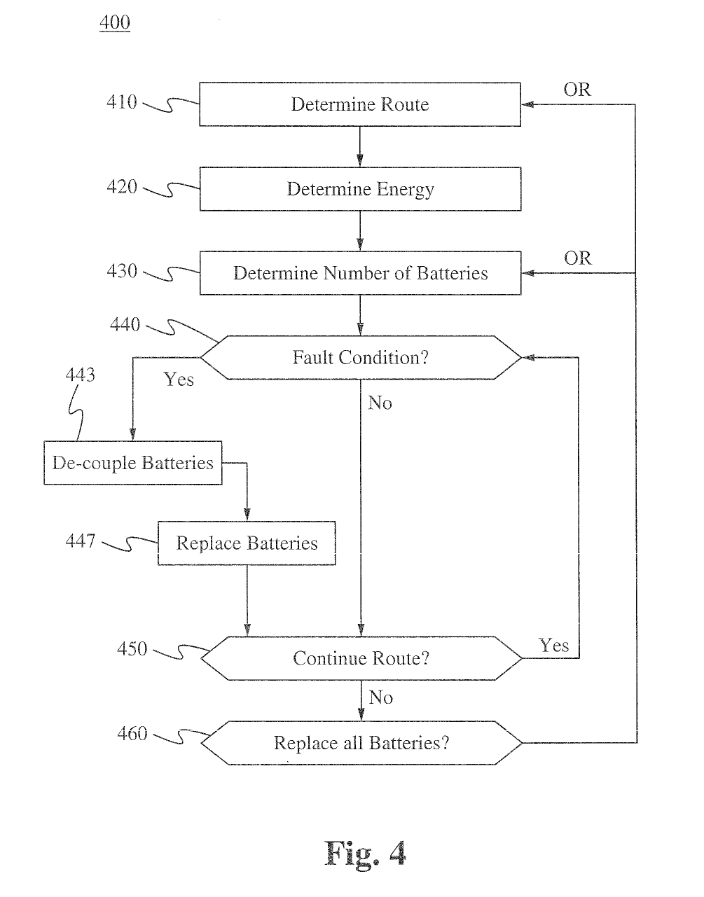

FIG. 4 is a flowchart 400 of a method of operating an EV having a connection backplane for receiving several modular batteries in accordance with an embodiment of this invention. In a first step 410, a route for an EV is determined. In some embodiments, the route is a bus route. Alternatively, the route is a daily commute for an urban dweller, a garbage collection route, a postal route, a delivery route, or any other predetermined route. Determining a route also comprises determining traffic conditions, elevation changes, stops along a bus line, garbage pickup points, and any other information that will affect the amount of energy that the EV will require to complete the route, or any combination of these factors. When the route is determined, the method moves to step 420. In the step 420, the amount of energy, preferably in Kilowatt Hours, is determined based upon the determination of the route in step 410. The determination of step 420 is done with respect to the determined route as well as the energy requirement of the electric motor in the EV. In the example of an EV bus along a bus route, the average number of passengers along the route at a particular time of day is taken into account, since the weight of the EV bus will be greatly affected and thereby the energy required. In the example of a garbage truck, an average amount and weight of garbage collected along a route should be known and taken into account when determining the amount of energy required to complete a route.

Those of ordinary skill in the art with the benefit of this disclosure will readily appreciate other factors for specific applications that must be considered to accurately forecast the energy required for a route. When the energy is determined, the next step 430 is taken. In a step 430, an appropriate number of modular batteries is determined. The appropriate number of modular batteries is the number of modular batteries required to provide the energy determined in step 420. In some embodiments, the determination of step 430 is made by an on board controller, through an interface similar to the controller 120 and display 125 of FIG. 1A. In these embodiments, an operator inputs the route, and the controller determines the number of batteries required. Alternatively, a user determines how many batteries are required for the route since the energy capacity of each battery is known. It is desirable to include headroom in the amount of energy available for any unplanned detours. For example, if a route calls for an amount of energy stored in 4 and one half batteries, 5 should be used.

Later, during operation of the EVs, in a step 440, a controller, such as the controller 120 of FIG. 1A monitors each individual modular battery. The controller monitors remaining energy and queries for any fault conditions or malfunctions in a battery. If there is no fault condition, the method moves to step 450, where the route continues. If there is a fault condition, the method moves to step 443, where the malfunctioning battery is at least electrically de-coupled from the connection backplane 130 of FIG. 2. Electrical de-coupling of the malfunctioning battery stops any further damage thereto. At that point, it must be determined whether the remaining batteries have enough charge to finish the route. To that end, the method moves to step 447. The controller determines the remaining charge on the remaining batteries and determines whether the total charge on the batteries is sufficient to complete the route to the bus depot of FIG. 4. If so, the malfunctioning battery is replaced at the next possible location, such as the kiosk in FIG. 3. Alternatively, a maintenance person delivers batteries sufficient to replace the number of malfunctioning batteries to the EV bus along its route. Advantageously, any option results in minimal interruption to the operation of the EV bus since, as described above in reference to FIGS. 2A and 2B, the batteries are configured to be easily removable, and the backplane allows for modular removal and replacement of batteries very quickly and with little effort.

The amount of time required make a battery swap is on the order of the amount of time the EV bus must stop so that passengers can embark and disembark. In the step 450, the EV bus continues its route. During continuation of the route, the controller continues to monitor the batteries. As a result, steps 440 and steps 450 occur substantially simultaneously. At the end of the route, all batteries are replaced in a step 460. The discharged batteries are placed in charging environments and fresh batteries are swapped into the EV bus for the next route, and the method returns to step 410 if a new route is planned. If the same route is planned, only the number of batteries is determined, as in step 430.

A person of ordinary skill having the benefit of this disclosure will readily appreciate the benefits. In the broadest sense, a minimal number of batteries is used, thereby minimal weight is added to the EV 100, further enhancing efficiency. Prior art EVs have only one immovable battery, which is generally of a far greater size and weight than required for most daily commutes, especially in urban settings where a daily commute may be as little as 10 km. Referring to FIG. 1A, the controller 120 is able to indicate via the display 125 how many batteries to use for such a trip. Alternatively, the driver of the vehicle knows how many kilometers each battery is good for, and will adjust it accordingly. The great advantage becomes clear when using the same EV 100 for a longer trip. For example, if the driver wishes to use the same EV for a longer trip, all the driver must do is use more batteries. The backplane 103 is operable to receive a plurality of batteries, and no further arrangement, setup, wiring, or the like is necessary on the part of the driver.

While the invention has been described with reference to numerous specific details, one of ordinary skill in the art will recognize that the invention can be embodied in other specific forms without departing from the spirit and scope of the invention as defined by the appended claims. Thus, one of ordinary skill in the art will understand that the invention is not to be limited by the foregoing illustrative details.

What is claimed is:

1. In a power delivery system in an electric vehicle, a connection backplane comprising:
a. a plurality of mounting positions, each configured to receive a battery, wherein each mounting position has:
i. coupling means for routing power from at least one battery among the plurality of batteries to an electric motor; and
ii. coupling means for routing a communication signal between at least one battery and a powertrain controller;
wherein the connection backplane is operable to remove or add a battery during operation of the electric vehicle without impeding the operation.

2. The backplane of claim 1 wherein the mounting positions each comprise a latching mechanism for securing the plurality of batteries to the connection backplane.

3. The backplane of claim 1 further comprising a system ground.

4. The backplane of claim 3 wherein the system ground is electrically coupled to a chassis of the electric vehicle.

5. The backplane of claim 1 further comprising a power bus, wherein the power bus is electrically connected to each of the coupling means for routing power.

6. The backplane of claim 1 further comprising a communication bus, wherein the communication bus is electrically connected to each of the coupling means for routing a communication signal.

7. The backplane of claim 1 wherein the communications signal comprises a battery status signal.

8. The backplane of claim 7 wherein the battery status signal comprises an indication of the remaining energy within a battery.

9. The backplane of claim 7 wherein the battery status signal comprises an indication of the conductivity between a battery and the backplane.

10. The backplane of claim 7 wherein the battery status signal comprises an indication of the temperature of a battery.

11. The backplane of claim 1 wherein the communication signal comprises a battery control signal.

12. The backplane of claim 11 wherein the battery control signal comprises a shutdown instruction.

13. A method of powering an electric vehicle comprising:
a. determining an amount of energy required to power the electric vehicle for a predetermined route; and
b. coupling an appropriate number of batteries to the electric vehicle according to the determined amount of energy.

14. The method of claim 13 further comprising identifying a non functioning battery from among the appropriate number of batteries.

15. The method of claim 14 further comprising electrically decoupling the non functioning battery from the electric vehicle.

16. The method of claim 14 wherein the non functioning battery is a battery having a charge below a predetermined charge.

17. The method of claim 14 wherein the non functioning battery is an overheating battery.

18. The method of claim 13 further comprising recharging the batteries at the end of the predetermined route.

19. The method of claim 13 further comprising recharging the batteries at a charging point along the predetermined route.

20. The method of claim 13 further comprising swapping out discharged batteries with charged batteries at the end of the predetermined route.

21. The method of claim 13 further comprising swapping out discharged batteries with charged batteries along the predetermined route.
